(19) United States
(12) Patent Application Publication
(10) Pub. No.: US 2006/0040143 A1
(43) Pub. Date: Feb. 23, 2006

(54) Fuel cell

(76) Inventors: Osamu Aoki, Tokyo (JP); Kazuhiko Shinohara, Yokohama-shi (JP)

Correspondence Address: MCDERMOTT WILL & EMERY LLP, 600 13TH STREET, N.W., WASHINGTON, DC, 20005-3096, US

(21) Appl. No.: 10/520,618

(22) PCT Filed: Jun. 9, 2003
(86) PCT No.: PCT/JP03/07257

§ 371 Date: Jan. 10, 2005

(30) Foreign Application Priority Data
Jul. 10, 2002 (JP) 2002-201083

(51) Int. Cl. H01M 8/00

(52) U.S. Cl. 429/12; 429/40; 429/33

(57) ABSTRACT

A gas diffusion layer (6) is sandwiched between catalyst electrode layers (5) and separators (1, 2), and side faces (6A, 6B) of the gas diffusion layer (6) are arranged so as to face a gas inlet manifold (7) and outlet manifold (8), and partition the inlet manifold (7) and outlet manifold (8). In the gas diffusion layer (6), gas flows from the side face (6A) facing the inlet manifold (7), flows through the interior, and flows out from the side face (6B) facing the outlet manifold (8).

### FIELD OF THE INVENTION

The present invention relates to a polymer electrolyte fuel cell, and more particularly to a fuel cell which has a gas flow path on a gas diffusion layer so as to make a unit cell thinner.

### BACKGROUND OF THE INVENTION

JP2001-76747A published by the Japanese Patent Office in 2001 describes the formation of a gas flow path on a gas diffusion layer in order to make a unit cell thinner. A zig-zag shaped notch is made in a thin gas diffusion layer to form the gas flow path, and a separator is made thinner by eliminating the flow path formed on the separator surface so that the fuel cell can be made more compact.

### SUMMARY OF THE INVENTION

However, in this aforesaid prior art, gas flows along the notch formed on the gas diffusion layer, and gas cannot diffuse easily in the diffusion layer. As a result, most of the gas flows only through the notch, reaction gas is supplied only to the surface of the catalyst electrode layer in the vicinity of the notch, and the power generating performance of the fuel cell cannot be increased.

As the cross-sectional area of the gas flowpath decreases the thinner the gas diffusion layer is made in order to make the fuel cell more compact, the flow of reaction gas is obstructed, and this placed a further restriction on increasing the power generating performance of the fuel cell.

Moreover, between the catalyst electrode layer and separator, electrical conductivity decreases due to the notch formed on the gas diffusion layer, and the electrical resistance of the fuel cell also increases.

It is therefore an object of this invention to improve the power generating performance while making a fuel cell more compact.

In order to achieve above object, this invention provides a fuel cell, comprising a solid polymer electrolyte membrane, a catalyst electrode layer disposed on the solid polymer electrolyte membrane, a gas diffusion layer disposed on the catalyst electrode layer and a separator disposed on the gas diffusion layer and forming an inlet manifold and outlet manifold between the electrolyte membrane. One surface of the gas diffusion layer faces the inlet manifold, and the other surface of the gas diffusion layer faces the outlet manifold, the inlet manifold and outlet manifold being partitioned by the gas diffusion layer. Gas flows from the one surface facing the inlet manifold and into the gas diffusion layer, flows through the interior of the gas diffusion layer, and flows out from the other surface facing the outlet manifold.

The details as well as other features and advantages of this invention are set forth in the remainder of the specification and are shown in the accompanying drawings.

### BRIEF DESCRIPTION OF THE DRAWINGS

FIG. 1 is a plan view of a fuel cell according to this invention showing the state where one of separators of a unit cell is removed.

FIG. 2 is a cross-sectional view of the unit cell.

FIG. 3 is a plan view of the essential parts of a fuel cell according to the second embodiment of this invention, showing the state where one of the separators of the unit cell is removed.

FIG. 4 shows a cross-section through a line IV-IV of FIG. 3.

FIG. 5 shows an example of an application of the unit cell of FIG. 3, showing the state where one of the separators is removed.

FIG. 6 shows a modification of FIG. 3.

### DESCRIPTION OF THE PREFERRED EMBODIMENTS

### Embodiment 1

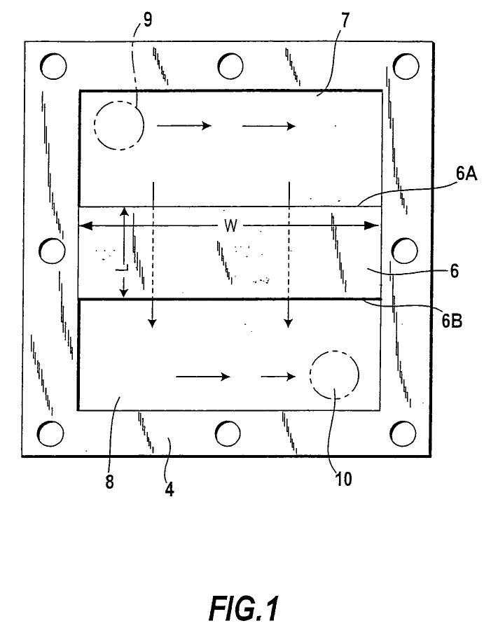

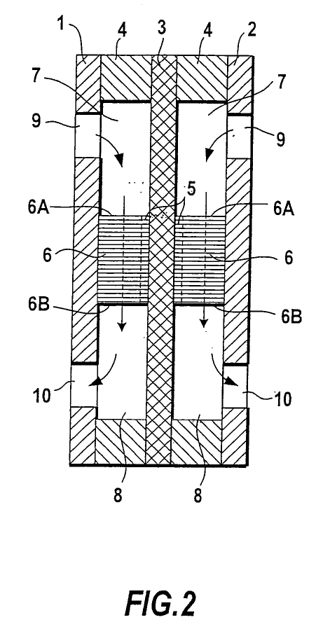

FIGS. 1, 2 show the first embodiment of a fuel cell according to this invention. FIG. 1 is a plan view showing the state where a separator of the unit cell of the fuel cell is removed, and FIG. 2 is a cross-sectional view of the unit cell.

In FIGS. 1, 2, in the fuel cell according to this embodiment, a solid polymer electrolyte membrane 3 is disposed between a pair of separators 1, 2, packings 4 are disposed between the rims of electrolyte membrane 3 and separators 1, 2 and anode and cathode spaces are formed on either side of the solid polymer electrolyte membrane 3. The anode and cathode spaces are partitioned by a catalyst electrode layer 5 and gas diffusion layer 6 and thus an inlet manifold 7 and outlet manifold 8 are formed on either side of the electrolyte membrane 3. An inlet port 9 which supplies gas (air or gas containing hydrogen) is formed in the separators 1, 2 and connected to the inlet manifold 7, and an outlet port 10 which discharges gas is formed in the separators 1, 2 and connected to the outlet manifolds 8.

The gas diffusion layer 6 is in contact with the separator 1 or 2, and is also in contact with the solid polymer electrolyte membrane 3 via the catalyst electrode layer 5. The entire surfaces of the wide sides 6A, 6B of the gas diffusion layer 6 respectively face the inlet manifold 7 and outlet manifold 8. The gas in the inlet manifold 7 flows from the wide side 6A to the gas diffusion layer 6, passes through the gas diffusion layer 6, and flows out from the opposite wide side 6B to the outlet manifold 8. The width W of the wide sides 6A, 6B of the gas diffusion layer 6 is larger than the length L of the wide sides 6A, 6B of the gas diffusion layer 6 as shown in FIG. 1.

The fuel cell having the above construction operates by supplying anode gas and cathode gas from the inlet ports 9 to the inlet manifolds 7. All of the gas in the inlet manifold 7 flows from the entire surface of the side 6A of the gas diffusion layer 6 into the gas diffusion layer 6, as shown by the arrows in the figures. The gas diffusion layer 6 is formed of carbon fibers such as carbon paper or carbon cloth, so gas can pass through the gaps between these fibers.

Gas which has entered travels inside the gas diffusion layer 6, and due to the fluidity of the gas itself in addition to gas diffusion, reaches the catalyst electrode layer 5 where gas exchange takes place. When gas first flows in from the side 6A of the gas diffusion layer 6, the flow is disordered, there is a large gas amount reaching the catalyst electrode layer 5 and the gas exchange amount is also large, but after the process has continued for some time, the flow stabilizes and the gas exchange amount decreases. As a result, as the gas directly diffuses into the catalyst electrode layer 5, the gas amount supplied for the electrochemical reaction in the catalyst electrode layer 5 is much increased compared to the gas exchange amount of the prior art which was due only to molecular diffusion, and the power generation amount therefore increases. Unreacted gas which was not subject to gas exchange passes through the gas diffusion layer 6, and flows out from the other side 6B to the outlet manifold 8.

Due to the gas flowing into and out of the gas diffusion layer 6, the water produced by condensation in the gas diffusion layer 6 in the vicinity of the catalyst electrode layer 5 is transported and discharged from the gas diffusion layer 6, so the performance in the high output operating region in which flooding due to this water can easily occur, is enhanced.

By making the length L of the gas diffusion layer 6 short, pressure losses are suppressed, and the gas amount passing through the system can be increased to promote gas exchange. Pressure losses increase, the work of the compressor which supplies gas to maintain the gas flowrate increases, and the overall efficiency of the fuel cell decreases, the longer the length L of the gas diffusion layer 6 is. Therefore, to promote gas exchange, the length L of the gas diffusion layer 6 is preferably shortened, and the width W of the gas diffusion layer 6 is preferably increased as far as possible in proportion to the gas amount passing through the system.

In the gas diffusion layer 6, as there is no notch, the catalyst electrode layer 5 and separators 1, 2 are continuous across their whole surfaces via the gas diffusion layer 6, so increase of electrical resistance in the fuel cell can be avoided.

To increase the surface area of the power generating surface, the width W of the gas diffusion layer 6 can be increased. The increase of the width W of the gas diffusion layer 6 makes the shape of the fuel cell effectively flatter.

The results of this embodiment are as follows:

(i) By sandwiching the gas diffusion layer 6 between the catalyst electrode layer 5 and separators 1, 2, the sides 6A, 6B of the gas diffusion layer 6 respectively face the gas inlet manifold 7 and outlet manifold 8, and thus the gas diffusion layer 6 partitions the inlet manifold 7 and outlet manifold 8. In the gas diffusion layer 6, gas flows in from the side 6A facing the inlet manifold 7, passes through the interior, and flows out from the side 6B facing the outlet manifold 8. Therefore, by promoting gas exchange in the gas diffusion layer 6 and discharge of condensed water from the gas diffusion layer 6, power generating performance is improved, and the size of the fuel cell is reduced.

Also, as the catalyst electrode layer 5 and separators 1, 2 are continuous over their whole surfaces, increase of electrical resistance of the fuel cell is avoided.

(ii) The width W is made larger than the length L of the gas diffusion layer 6, so gas exchange performance can be maintained while the suppressing pressure losses in the gas diffusion layer 6.

### Embodiment 2

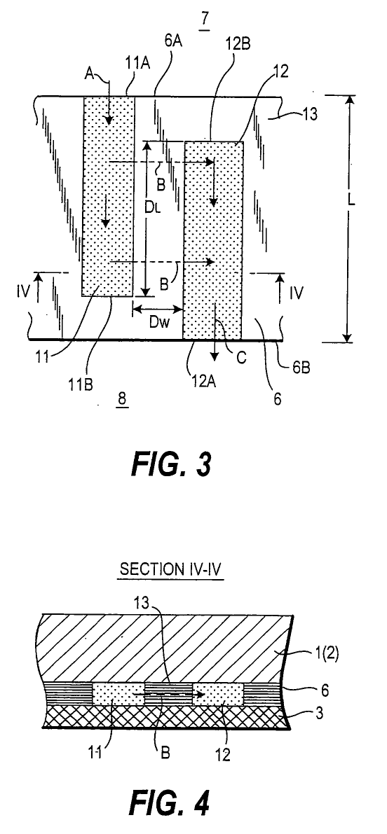

FIG. 3, FIG. 4 show a fuel cell according to the second embodiment of this invention. FIG. 3 is a plan view of the essential parts of the gas diffusion layer, and FIG. 4 is a partial cross-sectional view showing an enlargement of the region through which gas passes. Identical parts to those of the previous embodiment are assigned identical symbols and their description is omitted. A detailed description of those parts which are different will now be given.

In FIG. 3, the gas diffusion layer 6 comprises an end face 11A in contact with the inlet manifold 7 and an end face 12A in contact with the outlet manifold 8. An inlet high transmission region 11 and outlet high transmission region 12 which have a high gas transmission factor, respectively extend from the end faces 11A, 12A toward the outlet manifold 8 or inlet manifold 7 without reaching the outlet manifold 8 or inlet manifold 7, and are disposed at a certain distance apart.

The distance between the inlet high transmission region 11 and outlet high transmission region 12 is D_{W}, and the distance between the outlet manifold side end face 11B of the inlet high transmission region 11 and inlet manifold side end face 12B of the outlet high transmission region 12 is D_{L}. The gas transmission factor in the remaining regions apart from the high transmission regions 11, 12 is lower than that in the high transmission regions 11, 12, and this forms a low transmission region 13.

The gas flow resistance of the high transmission regions 11, 12 is low, whereas the gas flow resistance of the low flowrate region 13 is higher than that of the high transmission regions 11, 12. Gas reaches the low transmission region 13 from the inlet high transmission region 11 in contact with the inlet manifold 7, passes through the low transmission region 13, and flows into the outlet high transmission region 12 in contact with the outlet manifold 8. When the gas flows through the low transmission region 13, gas exchange takes place with the catalyst electrode layer 5.

Specifically, gas flows from the inlet manifold 7 to the inlet high transmission region 11 as shown by the arrow A in FIG. 3, flows into the low transmission region 13 as shown by the arrow B, and then flows through the outlet high transmission region 12 as shown by the arrow C out to the outlet manifold 8. When the gas flows through the low transmission region 13, gas exchange takes place in the gas diffusion layer 6, and discharge of condensed water is promoted.

As the flow resistance in the high transmission regions 11, 12 is small and gas flows smoothly, even if the length L of the gas diffusion layer 6 is long, the pressure losses are mainly the pressure losses when gas passes through the low transmission region 13 of width D_{W} and length D_{L} having a low gas transmission factor disposed between the high transmission regions 11, 12, so pressure losses can be suppressed small.

Also, according to this embodiment, a notch is not formed in the gas diffusion layer 6, the catalyst diffusion layer 5 and separators 1, 2 are continuous with the gas diffusion layer 6 over their whole surface, and increase of electrical resistance in the fuel cell can be avoided.

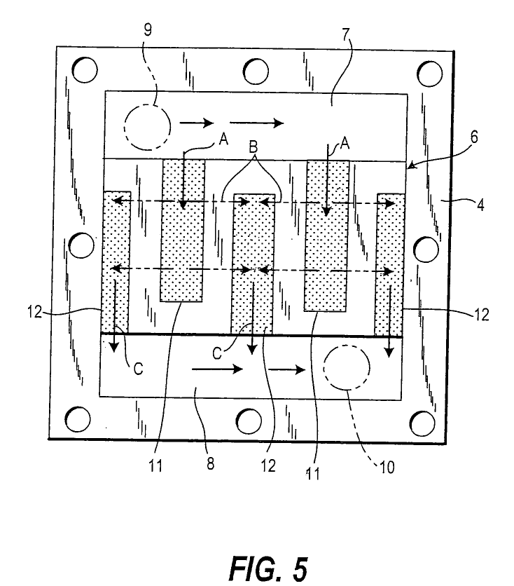

As shown in FIG. 5, the width of the power generating surface can be increased by repeating the pattern shown in FIG. 3. Also, the length of the power generating surface can be increased by increasing the distance between the inlet and outlet manifolds 7, 8 and lengthening the length of the high transmission regions 11, 12, so there is no need to flatten the fuel cell to increase the area of the power generating surface. There are therefore less restrictions on the shape of the fuel cell and less restrictions on the position of the fuel cell in the vehicle, so it is easier to install.

The gas diffusion layer 6 can be manufactured by incorporating a carbon fiber such as carbon paper or carbon cloth having a high gas transmission factor, and a carbon fiber such as carbon paper or carbon cloth having a low gas transmission factor. According to this method, when the two types of carbon fibers are manufactured, the carbon fiber having a high gas transmission factor must be inserted into a notch in the carbon fiber having a low gas transmission factor to form a composite body. A high degree of skill is required for handling during assembly, and the manufacturing cost also increases somewhat.

Other methods of making the gas transmission factor different at a desired site are as follows.

In the first method, in the high transmission regions 11, 12 having a high gas transmission factor, the numerical density of the carbon fibers forming the gas diffusion layer 6 is made smaller than the numerical density of the carbon fibers of the low transmission region 13 having a low gas transmission factor. Specifically, short carbon fibers are arranged on a flat surface and are then hardened to make the gas diffusion layer 6, but when the fibers are laid on the flat surface, the amount of short carbon fibers is varied according to the site. According to this method, some roughnesses are produced at the interfaces where the gas transmission factor is different, but there is no difference in the performance of the obtained gas diffusion layer 6, and manufacturing cost is low.

In the second method, the diameter of the carbon fibers in the high transmission regions 11, 12 having a high gas transmission factor is made larger than the diameter of the carbon fibers in the low transmission region 13 having a low gas transmission factor. When short carbon fibers are disposed on a flat surface and these are hardened to manufacture the gas diffusion layer 6, the diameter of the fibers is varied according to the site. Some roughnesses are produced at the interface where the gas transmission factor is different, but the performance of the obtained gas diffusion layer 6 is unchanged, and manufacturing cost is low.

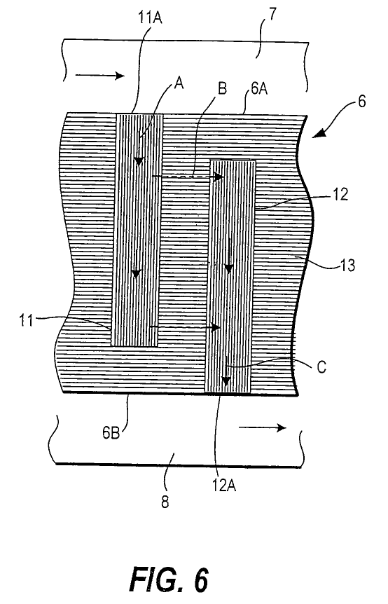

In the third method, as shown in FIG. 6, the fibers forming the gas diffusion layer 6 are arranged in the flow direction of the gas. By giving directionality to the fibers, the flow direction can be controlled even if the numerical density and diameter of the fibers is fixed.

Specifically, in the low transmission region 13 of the gas diffusion layer 6 having a low gas transmission factor, the fibers are arranged in a direction parallel to the end faces 6A, 6B in contact with the inlet manifold 7 and outlet manifold 8. On the other hand, in the high transmission regions 11, 12 of the gas diffusion layer 6 having a high gas transmission factor, the fibers are arranged perpendicular to the end faces 6A, 6B in contact with the inlet manifold 7 and outlet manifold 8. Next, these are hardened to manufacture the gas diffusion layer 6. According also to this method, the gas diffusion layer 6 can be manufactured at low cost.

The gas in the inlet manifold 7 flows into the gas diffusion layer 6 as shown by the arrow A along the fibers of the inlet high transmission region 11 where the fiber ends are exposed on the end faces of the gas diffusion layer 6, and then flows into the low transmission region 13 as shown by the arrow B. Next, it flows out to the outlet manifold 8 from the outlet high transmission region 12 where the fiber ends are exposed on the outlet manifold 8, as shown by the arrow C. The gas transmission factor can be regulated by selecting the numerical density and diameter of the fibers.

According to this embodiment, in addition to the results (i) and (ii) of the first embodiment, the following results are obtained.

(iii) The gas diffusion layer 6 is formed by the high transmission regions 11, 12 having a high gas transmission factor, and the low transmission region 13 having a lower gas transmission factor than the high transmission regions. The high transmission regions 11, 12 having a high gas transmission factor comprise the inlet high transmission region 11 extending from the side face 6A in contact with the inlet manifold 7 toward the outlet manifold 8 but not reaching the outlet manifold 8, and the outlet high transmission region 12 extending from the side face 6B in contact with the outlet manifold 8 toward the inlet manifold 7 but not reaching the inlet manifold 7, and the remaining region is the low transmission region 13 having a low gas transmission factor.

As a result, the low transmission region 13 having a low gas transmission factor is disposed lengthwise between the inlet manifold 7 and outlet manifold 8, the inlet manifold 7 and outlet manifold 8 can be separated as necessary, and flattening of the fuel cell can be avoided.

(iv) According to the first manufacturing method of the gas diffusion layer 6, the gas transmission factors of desired sites are made different from those of other sites by adjusting the numerical density of the fibers, so the gas diffusion layer 6 can be manufactured at low cost.

(v) According to the second manufacturing method of the gas diffusion layer 6, the gas transmission factors of desired sites are made different from those of other sites by adjusting the diameter of the fibers, so the gas diffusion layer 6 can be manufactured at low cost.

(vi) According to the second manufacturing method of the gas diffusion layer 6, in the high transmission regions 11, 12 having a high gas transmission factor, the fibers are arranged perpendicularly to the side faces 6A, 6B facing the inlet manifold 7 or outlet manifold 8, whereas in the low transmission region 13 having a low gas transmission factor, the fibers are arranged in a direction parallel to the end faces 6A, 6B, so the gas diffusion layer 6 can be manufactured at low cost. Moreover, the gas transmission factor can be regulated by adjusting the numerical density or diameter of the fibers.

In the aforesaid first embodiment, one gas diffusion layer 6 partitions the inlet manifold 7 and outlet manifold 8, however, although this is not shown, pressure losses can be reduced and power generating performance can be improved by for example partitioning three manifolds by two gas diffusion layers, the manifolds at the two ends being inlet manifolds (or outlet manifolds), and the middle manifold being the outlet manifold (or inlet manifold).

Also, according to the second embodiment, the case was described where the part where gas flows through the low transmission region 13 having a low gas transmission factor is limited to a part between the high transmission regions 11, 12 having a high gas transmission factor, however, although not shown, the gas may be made to flow also through the low transmission region 13 having a low gas transmission factor between the ends of the high transmission regions 11, 12 having a high gas transmission factor and the outlet manifold 8 or inlet manifold 7.

The entire contents of Japanese Patent Application P2002-201083 (filed Jul. 10, 2002) are incorporated herein by reference.

Although the invention has been described above by reference to certain embodiments of the invention, the invention is not limited to the embodiments described above. Modifications and variations of the embodiments described above will occur to those skilled in the art, in the light of the above teachings. The scope of the invention is defined with reference to the following claims.

### INDUSTRIAL FIELD OF APPLICATION

This invention may be applied to a polymer electrolyte fuel cell, and is useful for improving power generating performance while making the fuel cell more compact. This invention is not limited to vehicles, and may be applied also to fuel cells used in other systems.

1. A fuel cell, comprising:
a solid polymer electrolyte membrane;
a catalyst electrode layer disposed on the solid polymer electrolyte membrane;
a gas diffusion layer disposed on the catalyst electrode layer; and
a separator disposed on the gas diffusion layer and forming an inlet manifold and outlet manifold between the electrolyte membrane, wherein:
one surface of the gas diffusion layer faces the inlet manifold, and the other surface of the gas diffusion layer faces the outlet manifold, the inlet manifold and outlet manifold being partitioned by the gas diffusion layer; and
gas flows from the one surface facing the inlet manifold and into the gas diffusion layer, flows through the interior of the gas diffusion layer, and flows out from the other surface facing the outlet manifold.

2. The fuel cell as defined in claim 1, wherein:
the width of the gas diffusion layer in a direction perpendicular to the laminar direction of the cells is formed larger than the distance between the one surface and the other surface.

3. The fuel cell as defined in claim 1, wherein:
the gas diffusion layer comprises a high transmission region and a low transmission region having a smaller gas transmission factor than the high transmission region,
the high transmission region comprises an inlet high transmission region extending from the one surface toward the outlet manifold without reaching the outlet manifold, and an outlet high transmission region extending from the other surface toward the inlet manifold without reaching the outlet manifold, the inlet high transmission region and the outlet high transmission region being disposed at a certain distance apart, and:
the low transmission region is a remaining region apart from the high transmission region of the gas diffusion layer.

4. The fuel cell as defined in claim 3, wherein:
the distance between the an outlet manifold side end face of the inlet high transmission region and an inlet manifold side end face of the outlet high transmission region, is longer than the distance between the inlet high transmission region and outlet high transmission region.

5. The fuel cell as defined in claim 3, wherein:
the numerical density of the fibers in the high transmission region is smaller than the numerical density of the fibers in the low transmission region.

6. The fuel cell as defined in claim 3, wherein:
the diameter of the fibers in the high transmission region is larger than the diameter of the fibers in the low transmission region.

7. The fuel cell as defined in claim 3, wherein:
in the high transmission regions, fibers are arranged in a direction perpendicular to the surface of the gas diffusion layer in contact with the manifold, and
in the low transmission region, fibers are arranged in a direction parallel to the surface of the gas diffusion layer in contact with the manifold.
